(19) United States
(12) Patent Application Publication
(10) Pub. No.: US 2006/0211784 A1
(43) Pub. Date: Sep. 21, 2006

(54) Polyurethane foam with improved properties and stuffed structure comprised of said foam

(76) Inventor: Alberto Veneruso, Latina (IT)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/376,079

(22) Filed: Mar. 15, 2006

(30) Foreign Application Priority Data
Mar. 18, 2005 (IT) RM2005A000125

(51) Int. Cl. C08J 9/00

(52) U.S. Cl. 521/99

(57) ABSTRACT

The invention relates to a polyurethane foam comprising, for 100 parts by weight of a polyol, between 15 and 30 parts by weight of graphite, between 4 and 10 parts by weight of hollow charges of a glass material, and between 50 and 70 parts by weight of isocyanate.

This application claims priority under 35 U.S.C. §119(a) to Italian Patent Application No. RM2005A000125, filed Mar. 18, 2005. The foregoing application is incorporated by reference herein.

### FIELD OF THE INVENTION

The present invention relates to polyurethane foams with improved properties and stuffed structures comprising said foam. More specifically, the invention relates to a stuffed structure which can be made as a very light structure without jeopardizing its other properties, such as, mechanical strength, density, and fire behavior. The present invention is particularly suitable for the aeronautic field, however, it is applicable to any other field.

### BACKGROUND OF THE INVENTION

For many years, solutions have been sought in the aeronautic field for creating stuffed structures for seats which satisfy the limiting requirements of aeronautic tests. In particular, stuffed structures which are sufficiently comfortable have been sought which are made as light as possible.

Specifically, it would be desirable to create polyurethane foams suitable for molding cushions which satisfy aeronautic requirements. Preferably, the polyurethane foam would have the following features:
fire behavior: passing the Oil Burner Test (ref: Federal Aviation Regulations (FAR) 25, Appendix F, Part III); and
density: <=60 Kg/m³.

Recently, cushions have been generated which comprise polyurethane foam with the addition of graphite in order to tar the compound and confer to the polyurethane foam anti-flame properties that the polyurethane foam does not have. Examples of this kind are described in European Patents EP 0414868 and EP 0450403, both in the name of Metzeler Schaum GmbH. A process is described in both patents for manufacturing a polyurethane foam which is flexible, elastic, has anti-flame properties wherein a polyol and a polyisocyanate are mixed with graphite.

The introduction of a particular kind of graphite in the reaction mixture, as suggested in the above patents, produced a polyurethane foam with good physical and mechanical properties and capable of passing the Oil Burner Test. However, these polyurethane foams have drawbacks. In particular, the density of the foamed piece obtained by the above mixture had to be at least 70 Kg/m³ in order to pass the Oil Burner Test. This density is too high for aeronautic cushions and is a serious limit to the commercialization of these cushions.

In view of the above, there is a clear need to obviate the above described drawback. Specifically, methods for producing structures stuffed with a polyurethane foam that satisfies the Oil Burner Test requirements and, at the same time, allows for the formation of a structure with a much lower density with respect to the previously produced structures comprising polyurethane foam.

### SUMMARY OF THE INVENTION

Superior stuffed structures are obtained according to the present invention by producing a polyurethane foam generated from a reaction mixture comprising a very light component, particularly hollow glass microspheres, the low density of which (about 150 Kg/m ³) contributes to raise the volume of the liquid mixture before expansion.

Exemplary polyurethane foams of the instant invention comprise, for 100 parts in weight of a polyol, between 15 and 30 parts in weight of graphite, between 4 and 10 parts in weight of hollow charges of a glass material, and between 50 and 70 parts in weight of isocyanate. In a preferred embodiment, the polyurethane foam comprises between 18 and 25 parts in weight of graphite and more preferably comprises 20 parts in weight of graphite.

In a particular embodiment of the invention, the graphite is an expandable graphite.

In yet another embodiment of the invention, the polyurethane foam comprises between 6 and 8 parts in weight of hollow charges of glass material, more preferably the polyurethane foam comprises 7 parts in weight of hollow charges of glass material.

In a particular embodiment of the invention, the isocyanate is modified diphenylmethane 4,4′diisocyanate.

In still another embodiment, the hollow structures of glass material are hollow glass microspheres.

According to one aspect of the instant invention, the hollow charges of glass material can be mixed with polyol, with isocyanate or with both of them during the production of the polyurethane foam.

According to yet another aspect of the invention, triethyl phosphate can be added, particularly in an amount of 1 to 5 parts in weight, preferably 2 to 4 parts in weight, and still more preferably 3 parts in weight, with respect to 100 parts of polyol.

The instant invention further relates to a stuffed structure employing a polyurethane foam as described in the above.

### DETAILED DESCRIPTION OF THE INVENTION

By employing the polyurethane foam according to the instant invention, a reduction of density of about 15% can be obtained.

As already mentioned, different possible combinations of components can be employed to synthesize the polyurethane foams of the invention.

The physical and chemical features of the components and the weight composition of the reaction mixture are provided hereinbelow for illustrative, but not limitative purposes.

The amount of isocyanate employed is variable (also in composition C) as the softness of the synthesized polyurethane foam is determined by the amount of isocyanate (i.e., the higher is the amount of isocyanate, the harder is the cushion obtained; the lower is the amount of isocyanate, the softer is the cushion obtained).

When providing percentages and composition of the polyurethane compound, 100 parts in weight of polyol is used as a standard to which the amount of the other components are referred. Obviously, if the percentage composition is desired, the polyol proportion can be varied accordingly.

Formulas 1 and 2, provided hereinbelow in Table 2, take into consideration only the main components (polyol, isocyanate, graphite and microspheres). In Formula 1, the solid parts (graphite and microspheres) are all dispersed within polyol. In Formula 2, the solid parts are dispersed both in component “a” (polyol) and in component “b” (isocyanate).

A fifth component is introduced in Formula 3: triethyl phosphate (TEP). TEP is a low viscosity anti-flame liquid which affords two advantages:
easy workability of the mixture; and
ability to pass the Oil Burner Test.

In a particular embodiment, diphenyl methane 4,4′diisocyanate (MDI) having the features set forth in Table 1 are employed.

TABLE 1

| | % NCO | | |
|---|---|---|---|
| | 20-30 | 22-28 | 27 |
| functionality | 2-3 | 2.2-2.7 | 2.3 |

Expandable graphite may be employed as the graphite. Additionally, the very light component of the reaction material may be microspheres comprised of fine grain inert mineral powders, such as hollow glass microspheres.

TABLE 2

| | FORMULA 1 | | | FORMULA 2 | | | FORMULA 3 | | |
|---|---|---|---|---|---|---|---|---|---|
| | A | B | C | A | B | C | A | B | C |
| Comp “a” | | | | | | | | | |
| polyol | 100 | 100 | 100 | 100 | 100 | 100 | 100 | 100 | 100 |
| graphite | 15-30 | 18-25 | 20 | 15-30 | 18-25 | 20 | 15-30 | 18-25 | 22 |
| microspheres | 4-10 | 6-8 | 7 | — | — | — | | | |
| TEP | — | — | — | — | — | — | 1-5 | 2-4 | 3 |
| Comp “b” | | | | | | | | | |
| isocyanate | 50-70 | 50-70 | 50-70 | 50-70 | 50-70 | 50-70 | 50-70 | 50-70 | 50-70 |
| microspheres | — | — | — | 6-12 | 8-10 | 9 | 6-12 | 8-10 | 9 |

The present invention has been described for illustrative but not limitative purposes, according to its preferred embodiments, but it is to be understood that modifications and/or changes can be introduced by those skilled in the art without departing from the relevant scope as defined in the enclosed claims.

Patent documents are cited in the foregoing specification in order to describe the state of the art to which this invention pertains. The entire disclosure of these citations is incorporated by reference herein.

What is claimed is:

1. A polyurethane foam comprising, for 100 parts by weight of a polyol, between 15 and 30 parts by weight of graphite, between 4 and 10 parts by weight of hollow charges of a glass material, and between 50 and 70 parts by weight of isocyanate.

2. The polyurethane foam according to claim 1, wherein said graphite is between 18 and 25 parts by weight.

3. The polyurethane foam according to claim 2, wherein said graphite is 20 parts by weight.

4. The polyurethane foam according to claim 1, wherein said graphite is expandable graphite is employed.

5. The polyurethane foam according to claim 1, wherein said hollow charges of glass material are between 6 and 8 parts by weight.

6. The polyurethane foam according to claim 5, wherein said hollow charges of glass are 7 parts by weight.

7. The polyurethane foam according to claim 1, wherein said isocyanate is modified diphenyl methane 4,4′diisocyanate.

8. The polyurethane foam according to claim 1, wherein said hollow charges of a glass material are glass hollow microspheres.

9. The polyurethane foam according to claim 1, wherein said hollow charges of glass material are mixed with polyol, isocyanate, or both during the synthesis of said polyurethane foam.

10. The polyurethane foam according to claim 1, wherein said polyurethane foam further comprises between 1 and 5 parts by weight of triethyl phosphate.

11. The polyurethane foam according to claim 10, wherein triethyl phosphate is between 2 and 4 parts by weight.

12. The polyurethane foam according to claim 10, wherein triethyl phosphate is 3 parts by weight.

13. A stuffed structure comprising the polyurethane foam according to claim 1.
